(19) United States
(12) Patent Application Publication
(10) Pub. No.: US 2005/0126702 A1
(43) Pub. Date: Jun. 16, 2005

(54) Assembly for connecting two thermoplastic tubular elements

(76) Inventor: Georges-Andre Frey, La Croix-sur-Lutry (CH)

Correspondence Address: NIXON & VANDERHYE, PC, 1100 N GLEBE ROAD, 8TH FLOOR, ARLINGTON, VA, 22201-4714, US

(21) Appl. No.: 10/520,165

(22) PCT Filed: Jul. 7, 2003
(86) PCT No.: PCT/CH03/00444

(30) Foreign Application Priority Data
Jul. 8, 2002 (CH) 1195/02

(51) Int. Cl. B32B 31/00

(52) U.S. Cl. 156/294; 156/423; 156/379.7

(57) ABSTRACT

The invention concerns an assembly for fixing two thermally non-expansible thermoplastic tubular elements (1, 2) characterized in that it comprises a first thermally non-expansible thermoplastic tubular element (1) including a fixing zone (4) on the inner wall of one of its ends, a second thermally non-expansible thermoplastic tubular element including a fixing zone (6) on the outer wall of one of its ends, the diameter of the inner wall of said end of the first tubular element (1) being larger than the diameter of the outer wall of said end of the second tubular element (2) so as to define, when the two ends overlap, an annular space between said inner and outer walls, the assembly further comprising a thermoplastic sleeve (3) adapted to be housed in the annular space, said sleeve (3) containing a conductive element (5) capable of being induction-heated.

The present invention relates to an assembly for fusion bonding two thermally nonexpansible thermoplastic tubular elements. The invention also relates to a method of bonding thermoplastic tubular elements together using said assembly.

Assemblies for bonding two thermally nonexpansible thermoplastic tubular elements, as a result of their contact zones being fused together by heating, are known. The heating may be carried out by creating a magnetic field (induction heating) or a current (resistance heating) in a conducting element incorporated in one of the thermoplastic tubular elements. Such systems are disclosed in patent documents WO 80/02124, EP 0 480 053 A1, U.S. Pat. No. 4,634,844 and WO 81/02405.

The systems of the prior art are relatively expensive and complicated to produce owing to the insertion of the conducting element into the tubular element.

One of the objects of the present invention is to simplify the assemblies for fusion bonding two tubular elements together.

Another object relates to the possibility of using existing tubular elements which do not contain conducting elements in their bonding zones but which, at the cost of a very simple modification of the internal diameter of one of the tubular elements, can be fusion bonded together.

These objects are achieved by producing an assembly for fusion bonding two thermally nonexpansible thermoplastic tubular elements together, characterized in that it comprises a first thermally nonexpansible thermoplastic tubular element having a bonding zone on the internal wall of one of its ends, a second thermally nonexpansible thermoplastic tubular element having a bonding zone on the external wall of one of its ends, the diameter of the internal wall of said end of the first tubular element being greater than the diameter of the external wall of said end of the second tubular element so as to define, when the two ends overlap, an annular space between said internal and external walls, the assembly furthermore including a thermoplastic sleeve suitable for being housed in said annular space, said sleeve containing a conducting element that can be heated by induction.

The term “thermoplastic” should be understood to mean any plastic that melts under the action of heat, or at the very least softens sufficiently to be able to be formed an infinite number of times without its properties being modified. By way of nonlimiting examples of thermoplastics that can be used within the context of the present invention, mention may be made of polypropylene, polybutene, polyethylene or any other similar synthetic resin.

The tubular elements used within the context of the present invention may have any shape. One of the elements may be a coupler, an angled element or a T-shaped element.

The invention also relates to a method of fusion bonding two tubular elements using the assembly described above, characterized by the following steps:
the diameter of the internal wall of the first tubular element is adjusted so as to be able to place the sleeve in said annular space;
the sleeve is placed around the end of the second tubular element;
the end of the second tubular element and of the sleeve is introduced into the end of the first tubular element; and
the bonding zone is heated and fused by induction heating.

The diameter of the internal wall of the first tubular element may be adjusted very simply. A coupler of smaller diameter than that desired is initially chosen and this coupler is then enlarged by means of a conventional machine.

An illustrative example of the invention will be described in greater detail by means of the following figures:

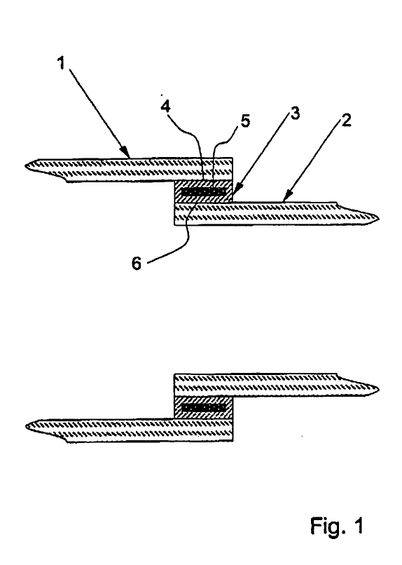

FIG. 1 shows a longitudinal section of an assembly for bonding two tubular elements together; and

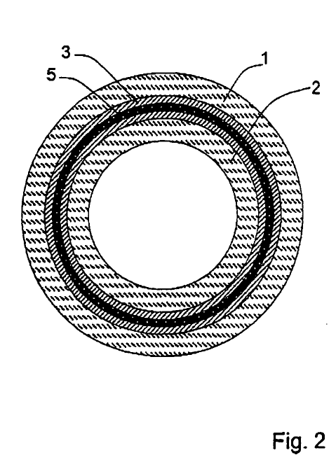

FIG. 2 shows a cross section of the assembly of FIG. 1.

The assembly illustrated in FIGS. 1 and 2 consists of a first thermoplastic tubular element 1 and a second thermoplastic tubular element 2, the outside diameter of the second tubular element 2 being smaller than the inside diameter of the first tubular element 1. The difference in diameter between the two tubular elements 1, 2 may for example be around 4 mm. The annular space created between the two tubular elements 1, 2 is occupied by a thermoplastic sleeve 3 that includes a ring-shaped conducting element 5. The thickness of the conducting element 5 may be of the order of 1 mm. The thickness of the thermoplastic sleeve 3 may be 2 mm. The internal diameter of the thermoplastic sleeve 3 may be around 40 mm and its length around 15 mm.

Once the assembly is in place, the conducting element 5 is heated by induction heating, therefore causing the thermoplastic material constituting the sleeve 3 and the adjacent walls of the tubular elements 1, 2 to melt. After cooling, the assembly forms a uniform block thermoplastic, ensuring that the tubular elements 1, are bonded together.

1. An assembly for fusion bonding two thermally nonexpansible thermoplastic tubular elements (1, 2) together, characterized in that it comprises a first thermally nonexpansible thermoplastic tubular element (1) having a bonding zone (4) on the internal wall of one of its ends, a second thermally nonexpansible thermoplastic tubular element (2) having a bonding zone (6) on the external wall of one of its ends, the diameter of the internal wall of said end of the first tubular element (1) being greater than the diameter of the external wall of said end of the second tubular element (2) so as to define, when the two ends overlap, an annular space between said internal and external walls, the assembly furthermore including a thermoplastic sleeve (3) suitable for being housed in said annular space, said sleeve (3) containing a conducting element (5) that can be heated by induction.

2. The assembly as claimed in the preceding claim, characterized in that the first tubular element is a coupler.

3. A method of fusion bonding two tubular elements together using the assembly of claim 1, characterized by the following steps:
the diameter of the internal wall of the first tubular element is adjusted so as to be able to place the sleeve in said annular space;
the sleeve is placed around the end of the second tubular element;
the end of the second tubular element and of the sleeve is introduced into the end of the first tubular element; and
the bonding zone is heated and fused by induction heating.
